(19) United States
(12) Patent Application Publication
(10) Pub. No.: US 2015/0365470 A1
(43) Pub. Date: Dec. 17, 2015

(54) Concurrent Scalable Data Content Scanning

(71) Applicant: Global Velocity, Inc., St. Louis, MO (US)

(72) Inventors: Timothy Palmer, Chesterfield, MO (US); Christopher Taylor, Valley Park, MO (US)

(73) Assignee: Global Velocity, Inc., St. Louis, MO (US)

(21) Appl. No.: 14/737,005

(22) Filed: Jun. 11, 2015

Related U.S. Application Data
(60) Provisional application No. 62/011,420, filed on Jun. 12, 2014.

(51) Int. Cl. H04L 29/08; H04L 29/06

(52) U.S. Cl. CPC H04L 67/10; H04L 69/16

(57) ABSTRACT

Through the use of remote actor (5) messaging, the system (10) described herein concurrently scans high volumes of digital information (1) to look for potential content matches using a variety of scan techniques and a variety of types of scanner (6) (e.g., fingerprint scanners, pattern scanners, dictionary scanners, etc.). The scanners (6) are organized into a plurality of scanner worker modules (5). Some or all of the scanner worker modules (5) can reside and operate together on the same device (computer) (4), or they can all be distributed across many horizontally scalable computers (4). This architecture (10) allows distributing the incoming digital content (1) to some or all of the scanners (6) at once, and have them all look for matches in parallel, i.e., simultaneously. It also allows a user to add new types of content scanning (6) and/or to modify scan parameters (23, 34) dynamically, without introducing unwanted latency into the system (10).

### RELATED APPLICATION

This patent application claims the priority benefit of U.S. provisional patent application 62/011,420 filed Jun. 12, 2014; said provisional patent application is hereby incorporated in its entirety into the present application.

### TECHNICAL FIELD

This invention pertains to the field of scanning digital data streams for content.

### BACKGROUND ART

The background art consists of various techniques for scanning digital data streams for content. These prior art techniques are typically slow, especially when multiple types of scans must be performed, and introduce unwanted latency into the system. These problems are successfully addressed by the present invention.

### DISCLOSURE OF INVENTION

Through the use of remote actor (5) messaging, the system (10) described herein concurrently scans high volumes of digital information (1) to look for potential content matches using a variety of scan techniques and a variety of types of scanner (6) (e.g., fingerprint scanners, pattern scanners, dictionary scanners, etc.). The scanners (6) are organized into a plurality of scanner worker modules (5). Some or all of the scanner worker modules (5) can reside and operate together on the same device (computer) (4), or they can all be distributed across many horizontally scalable computers (4). This architecture (10) allows distributing the incoming digital content (1) to some or all of the scanners (6) at once, and have them all look for matches in parallel, i.e., simultaneously. It also allows a user to add new types of content scanning (6) and/or to modify scan parameters (23, 34) dynamically, without introducing unwanted latency into the system (10).

### BRIEF DESCRIPTION OF THE DRAWINGS

These and other more detailed and specific objects and features of the present invention are more fully disclosed in the following specification, reference being had to the accompanying drawings, in which:

FIG. 1 is a block diagram illustrating the inventive system 10.

FIG. 2 is a block diagram of a control unit 9 that is used in each scanner worker module 5 in the present invention.

### DETAILED DESCRIPTION OF PREFERRED EMBODIMENTS

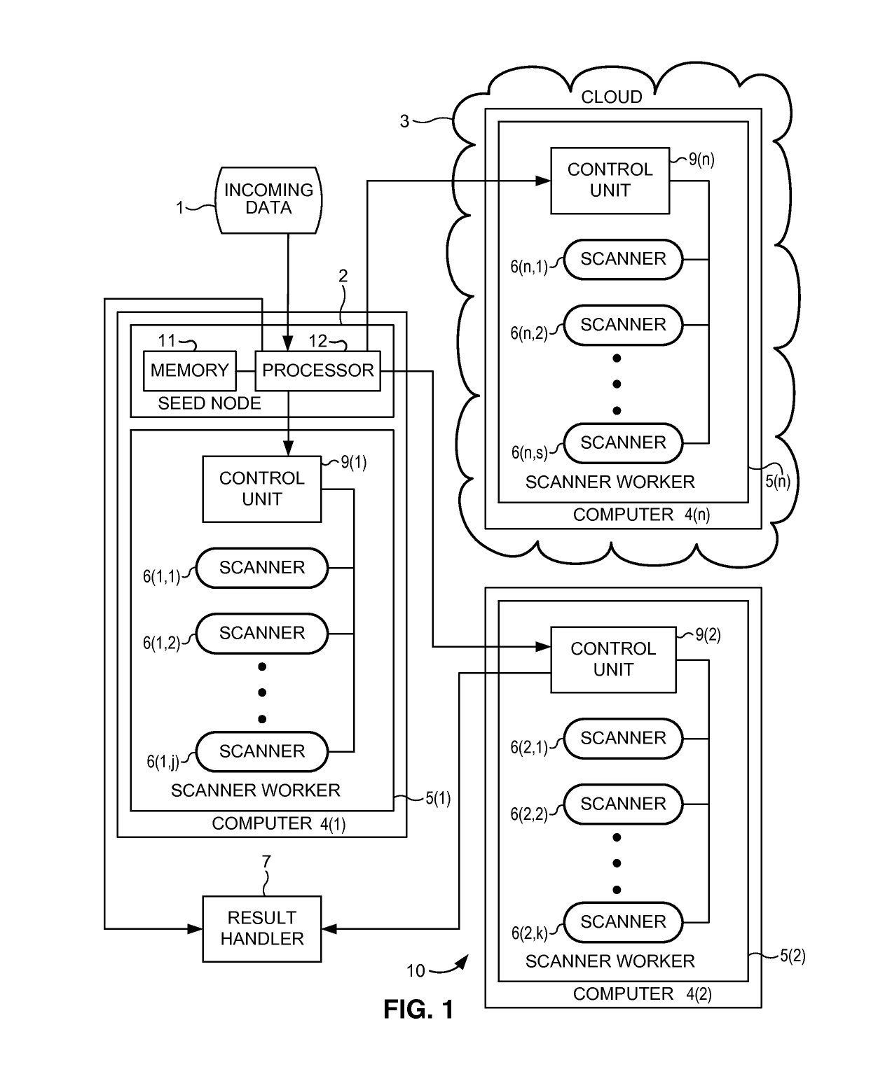

Please refer to FIG. 1. At a high level, the system 10 accepts incoming digital information 1, scans it for content using pre-defined match criteria using a distributed network of content scanners 6, then takes a specified action if a match is found. The use of a distributed, cluster-based scanner actor 6 model allows the system 10 to quickly scale to handle extremely large sets of data 1, and multiple simultaneous scans, with very low latency.

The content may be malware (viruses, worms, Trojans, etc.), evidence of copyright infringement, certain key words or phrases (“bomb”, “operation”, “event”, etc.) that are of interest to the entity performing the scanning, or any other type of content.

Information 1 passed into the system is processed by a seed node 2 using a cluster of scanner worker modules 5. A scanner worker 5 can be situated remotely from seed node 2 on the cloud 3, or be local with respect to the incoming data (and seed node 2). Each scanner worker 5 can be implemented in hardware, software, and/or firmware. When implemented in software, the software can reside on one or more non-transitory computer readable media. Each scanner worker 5 comprises a pool of individual scanner actor modules 6, where the pool is selected and sized to make optimum use of the resources of the computer 4 on which the pool is running. Each scanner actor 6 in the pool can be configured to perform a different type of scan.

FIG. 1 shows n computers 4; n is an arbitrary positive integer greater than 1. Each computer 4 hosts an associated scanner worker module 5. In turn, each scanner worker 5 comprises a plurality of individual scanner modules (scanner actors) 6. Scanner worker 5(1) is shown as having j scanner modules 6, where j can be any positive integer greater than 1. Scanner worker 5(2) is shown as having k scanner modules 6, where k can be any positive integer greater than 1. Scanner worker 5(n) is shown as having s scanner modules 6, where s can be any positive integer greater than 1.

The system 10 is governed by a single seed node 2. Seed node 2 can be a standalone module, or it can be hosted on one of the computers 4 that hosts a scanner worker 5, as illustrated in FIG. 1. Seed node 2 comprises a processor 12 that receives all incoming data 1, and distributes the data 1 to one or more of the scanner workers 5, based upon pre-determined distribution criteria contained in memory 11. The data can be organized into a plurality of packets or messages. The seed node 2 can be implemented in hardware, software, and/or firmware. When implemented in software, the software can reside on one or more non-transitory computer readable media. When a new scanner worker 5 is made available to the system 10, worker 5 first registers with seed node 2 by presenting proper credentials (see below), announcing that the worker 5 is ready to process units of incoming work 1.

Seed node 2 sends the incoming unit of work 1 to the assigned one or more of the waiting scanner workers 5 using one or more of a variety of routing techniques (including, without limitation, round-robin, least full mailbox, etc.). These techniques can be pre-stored in memory 11, and are typically selected to maximize throughput of the system 10. Memory 11, which can be updated dynamically by a user, also can be populated with other distribution criteria, such as the characteristics of scanner workers 5, and which characteristics are particularly well suited to the type of data that processor 12 is receiving.

Typically, all communications between the seed node 2 and the scanner workers 5 takes place over the TCP/IP layer. One or more scanner workers 5 can reside on the same computer 4; alternatively, all the scanner workers 5 can be distributed over many different computers 4 across a distributed computer network 10. Due to the distributed and asynchronous nature of system 10, several clusters containing one or more scanner workers 5 can be spread out over any number of host devices 4, physical, virtual, and/or in the cloud 3.

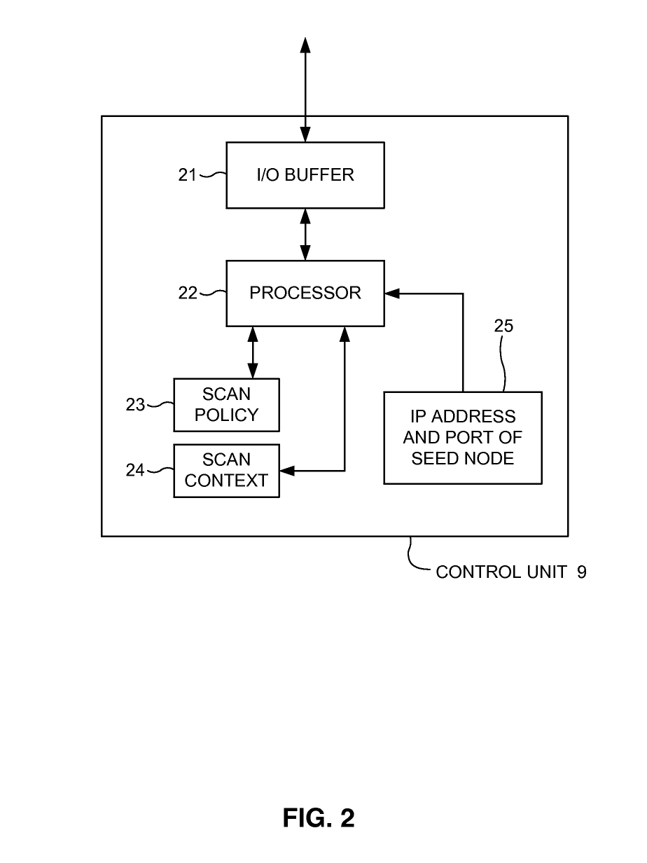

Each scanner worker 5 comprises a control unit 9 (see FIG. 2). Control unit 9 comprises a processor 22 for directing external communications with seed node 2 and with users wishing to update parameters within control unit 9, as well as internal communications within the associated scanner worker 5. Processor 22 communicates with seed node 2 via an optional input/output buffer 21, which reformats and time-buffers incoming and outgoing communications as necessary to insure efficient communications between processor 22 and seed node 2.

Scan policy memory 23, scan context memory 24, and seed node contact information memory 25 are also coupled to processor 22 within control unit 9. Memory 25 is preferably a read-only memory, but memories 23 and 24 are typically read-write memories, to facilitate the dynamic updating of memories 23, 24. This updating can be performed by a user introducing new or revised data into memories 23 and/or 24 via I/O buffer 21 and processor 22.

Memories 23 and 24 are initialized with a pre-selected scan policy and pre-selected scan context, respectively. The scan policy 23 dictates what types of information or clues (in the case of a forensic application) will be looked for within the incoming data 1, and what actions processor 22 needs to take when such information is detected. The scan context 24 provides the specific parameters that the scanners 6 associated with that control unit 9 need in order to search for the information dictated by the policy 23. For example, if the policy 23 is for processor 23 to record (log) the location in the incoming data 1 where a Social Security Number or a group of terms from a compliance dictionary is found, and to send the log to result handler 7, the scan policy memory 23 can be populated with the action (log) to be taken, the ID of the Social Security Number pattern, and the ID of the compliance dictionary. In this example, scan context memory 24 is populated with the actual definition for the Social Security Number regular expression, and the actual list of terms and weights defined in an associated compliance dictionary. Using this information, processor 22 determines which content analyzers 6 within the scanner worker 5 (in this example, a pattern analyzer 6 and a dictionary analyzer 6) to instantiate and activate; and what parameters 24 (the Social Security Number regular expression and the compliance dictionary terms) have to be used to instantiate said scanner actors 6.

All the content scanners within a scanner worker 5 analyze the incoming data 1 in parallel (simultaneously). New scanner types 6 can be added to a scanner worker 5 dynamically by a user, without adversely affecting the overall time to complete the content analysis.

Each control unit 9 comprises a memory 25 that contains the IP address and port of the seed node 2. This information 25 is used by processor 22 to let the seed node 2 know that the associated scanner worker 5 is ready to receive work. It is also a security feature, because only those scanner workers 5 presenting the correct IP address and port of seed node 2 are allowed by processor 12 to join the system 10.

The unit of incoming work 1 can be any type of digital data that a user wants to scan and enact policy on. Examples of work 1 include a group of static files, a network request, and/or a packet defining a command on an industrial controls network. After seed node 2 distributes the work 1 to one or more of the scanner workers 5, and when some sort of response is required or expected from scanner worker 5, as indicated by memory 11, seed node 2 sends a message to each cognizant scanner worker 5 and to result handler actor 7, announcing that the result handler 7 should be expecting a response from each cognizant worker 5. This technique frees seed node 2 from having to preserve status information for the unit of work 1, and allows processing to remain completely asynchronous across system 10. Processor 22 within each cognizant scanner worker 5 then distributes the unit of work 1 to one or more of the scanner actors 6 within worker 5, and keeps track of the action instructions that were issued by seed node 2. The results of the analysis are then checked by processor 22 against the pre-stored scan policy 23 to determine if a follow up action must be taken. If an action must be taken, processor 22 sends an incident report defining that action to result handler 7, again maintaining uninterrupted asynchronous flow. Result handler 7 then takes the action and sends an optional acknowledgement message back to each cognizant scanner worker 5. The action can be one or more of: pausing the processing of the incoming data 1 via instructions to seed node 2, deleting data 1 deemed to include malware, skipping the processing of data 1 for a certain number of bytes or for a certain period of time, or any other action known to one of ordinary skill in the content scanning art.

Result handler 7 can be implemented in hardware, software, and/or firmware. When implemented in software, the software can reside on one or more non-transitory computer readable media.

The techniques to finding matches in scanned content 1 described herein offer important advantages over the prior art, including the ability to scale quickly and adroitly to meet the needs of any sized data set 1; and the ability to add new scanners 6 and forms of data analysis 23, 24 dynamically, without adversely affecting throughput of the overall system 10.

The above description is included to illustrate the operation of preferred embodiments, and is not meant to limit the scope of the invention. The scope of the invention is to be limited only by the following claims. From the above description, many variations will be apparent to one skilled in the art that would yet be encompassed by the spirit and scope of the present invention.

What is claimed is:

1. A method for a seed node to direct the simultaneous content scanning of a unit of incoming data by a plurality of scanning modules, said method comprising the steps of said seed node:
receiving the incoming data unit;
directing the incoming data unit to one or more of a plurality of scanner workers, taking into account a set of pre-determined work distribution criteria, wherein:
each scanner worker comprises a plurality of individual scanning modules of various types, and a set of pre-selected scanning criteria.

2. The method of claim 1 wherein at least one scanner worker resides on the cloud.

3. The method of claim 1 wherein at least two scanner workers reside on the same computer.

4. The method of claim 1 wherein the directing step is conducted over the TCP/IP layer.

5. The method of claim 1 wherein each scanner worker comprises a control unit for communicating with the seed node, and for directing internal communications within the scanner worker.

6. The method of claim 5 wherein each control unit comprises:
a processor;
coupled to the processor, a memory containing scan policy associated with that scanner worker;
coupled to the processor, a memory containing scan context to be used in conjunction with the scan policy; and
coupled to the processor, a memory containing the IP address and port of the seed node.

7. The method of claim 6 wherein a user dynamically updates contents of at least one of the scan policy memory and the scan context memory.

8. The method of claim 1 further comprising the steps of the seed node:
determining, based upon pre-determined criteria, that processing of the incoming data unit requires affirmative action on the part of at least one scanner worker; and
sending a corresponding action message to a result handler module and to the scanner worker(s) that are required to take said affirmative action.

9. The method of claim 8 wherein a processor associated with the scanner worker performs the affirmative action and reports results of said performance to the result handler module.

10. Apparatus for simultaneously content scanning a unit of incoming data according to a plurality of pre-selected scanning criteria, said apparatus comprising:
a seed node adapted to receive the incoming data; and
coupled to the seed node, a plurality of scanner worker modules; wherein:
the seed node comprises a processor for determining which scanner worker module(s) will perform scanning of the input data, based upon pre-determined work distribution criteria stored in a memory coupled to the processor; and
each scanner worker module comprises a plurality of individual scanning modules of various types, and a set of pre-selected scanning criteria.

11. The apparatus of claim 10 wherein at least one scanner worker module resides on the cloud.

12. The apparatus of claim 10 wherein at least two scanner worker modules reside on the same computer.

13. The apparatus of claim 10 wherein the seed node and the scanner worker modules communicate with each over the TCP/IP layer.

14. The apparatus of claim 10 wherein each scanner worker module comprises a control unit adapted to communicate with the seed node and further adapted to regulate scanning by the plurality of individual scanning modules associated with the scanner worker module, based upon the set of scanning criteria.

15. The apparatus of claim 14 wherein each control unit comprises:
a processor;
coupled to the processor, a memory containing scan policy associated with that scanner worker module;
coupled to the processor, a memory containing scan context to be used in conjunction with the scan policy; and
coupled to the processor, a memory containing the IP address and port of the seed node, for enabling the processor to present proper credentials of its associated scanner worker module to the seed node.

16. The apparatus of claim 15 wherein the scan policy memory and the scan context memory are dynamically updatable by a user, via update information conveyed via the processor.

17. At least one non-transitory computer readable medium containing instructions for a seed node to direct the simultaneous content scanning of a unit of incoming data by a plurality of scanning modules, said instructions comprising the steps of the seed node:
receiving the incoming data unit; and
directing the incoming data unit to one or more of a plurality of scanner worker modules, taking into account a set of pre-determined criteria known to the seed node, wherein:
each scanner worker module comprises a plurality of individual scanning modules of various types, and a set of pre-selected scanning criteria.

18. The at least one computer readable medium of claim 17 wherein each scanner worker module comprises a control unit for communicating with the seed node, and for directing internal communications within the scanner worker module.
